(19) United States
(12) Patent Application Publication
(10) Pub. No.: US 2023/0057886 A1
(43) Pub. Date: Feb. 23, 2023

(54) POLYMER COMPOSITION COMPRISING GRAPHENE

(71) Applicant: Evonik Specialty Chemicals (Shanghai) Co., Ltd., Shanghai (CN)

(72) Inventors: Qunyue WANG, Shanghai (CN); Juan Guo, Shanghai (CN); Xiaojue Chen, Shanghai (CN); Urs Welz-Biermann, Lafayette, IN (US); Zhisheng Wang, Shanghai (CN)

(73) Assignee: Evonik Specialty Chemicals (Shanghai) Co., Ltd., Shanghai (CN)

(21) Appl. No.: 17/758,669

(22) PCT Filed: Jan. 14, 2020
(86) PCT No.: PCT/CN2020/072005

§ 371 Date: Jul. 12, 2022

(51) Int. Cl. C08K 3/04

(52) U.S. Cl. CPC C08K 3/042

(57) ABSTRACT

A polymer composition contains, based on a total weight of the polymer composition: a) 40 wt. % to 99 wt. % of a polyalkenamer derived from at least one cycloalkene having 5 to 12 carbon atoms, and b) 1 wt% to 60 wt. % of graphene. The polyalkenamer has a trans-isomer content larger than 50)wt.° /0 based on a weight of the polyalkenamer. A moulded article can be produced from the polymer composition, which can be a board, a film, a bristle, or a foam. The moulded article can be used as a clothing element, sport element, sealing material, electrically conductive article, friction control element, transportation element, or structural element.

### FIELD OF THE DISCLOSURE

The present disclosure relates to a polymer composition comprising graphene, to a process for producing the same and to the use thereof.

### BACKGROUND

Graphene is a two-dimensional allotrope of carbon in which the carbon atoms form a honeycomb-like structure. It has a spectrum of outstanding properties including high modulus of elasticity, excellent electrical and thermal conductivities. Graphene has been proposed as a versatile filler or modifier for polymers.

It has been found that graphene could be compounded into a variety of polymers, including polyethylene, polypropylene, polystyrene, etc. However, due to easy aggregation of graphene, especially for graphene nanosheets, dispersity in polymer of graphene remains a bottleneck for some applications which required the polymer to possess different features, such as, high conductivity and high mechanical strength at the same time.

KR 2012091709 A taught a polynorbornene/graphene oxide composite material formed through performing covalent bonding between modified graphene oxide and norbornene polymer. The modified graphene oxide is obtained through modifying the surface of graphene oxide with a compound having amine groups capable of reacting with epoxy groups existing on the surface of the graphene oxide at one end and a functional group capable of reacting with an anhydride group of the norbornene polymer at the other end. The polynorbornene is prepared through a catalysed ring open reaction.

Felix Kirschvink taught the synthesis of polymer-graphene nanocomposite by chain transfer with insitu ring-opening metathesis-polymerization of cis-cyclooctene in a doctoral dissertation titled

“Semikristalline Blockcopolymere, Graphen- and Gibbsit Nanokomposite durch Kettenubertragung bei der ringenenden Metathesepolymerisation von cis-Cycloocten” (available via http://d-nb.info/1125905557/34, KATALOG DER DEUTSCHEN NATIONALBIBLIOTHEK). Different nano-composite containing thermally reduced graphite oxide, undecanoic acid functionalized thermally reduced graphite oxide, or milled graphite were obtained via in-situ polymerization of cis-cyclooctene. The synthesis employed transition metal compounds as catalysts and toluene as solvent. Polyoctenamers with or without graphene as filler were reported to have a melting point of lower than 0° C., indicating a predominance of cis-isomers. Furthermore, the weight percentage of filler in the composite was very low. Filler content was under 7 wt. %, for thermally reduced graphite oxide; under 9 wt. %, for undecanoic acid-modified thermally reduced graphite oxide; and only 5 wt. %, for milled graphite.

Also known in the art is the solvent-based dispersion of graphene or exfoliated graphite into polymers. What makes the approach inappropriate for industrial application is resource and/or energy consumption incurred during dissolution of graphene and polymer in the solvent(s) and subsequent removal of the solvent(s).

Since graphene has been acknowledged as a promising modifier for various polymer applications, it is desired to prepare a polymer composition with a high concentration of graphene which can be easily dispersed in different polymer matrices. However, as graphene in powdery form may be very fluffy, its addition into polymer remains a technical challenge.

### SUMMARY

To this end, it was an object of the disclosure to provide a polymer composition comprising graphene in a high concentration.

This object was achieved with a polymer composition comprising, based on a total weight of the polymer composition: a) 40 wt. % to 99 wt. % of a polyalkenamer derived from at least one cycloalkene having 5 to 12 carbon atoms, wherein the polyalkenamer has a trans-isomer content larger than 50 wt. % based on a weight of the polyalkenamer, and b) 1 wt. % to 60 wt. % of graphene.

In one preferred embodiment, the graphene is selected from an exfoliated graphene, a thermally reduced graphene oxide, a functionalized graphene oxide, a mechanochemically prepared graphene, or a mixture thereof.

In one preferred embodiment, the polyalkenamer comprises a polyoctenamer.

In one preferred embodiment, the polyalkenamer has a melting point of higher than 5° C., preferably higher than 15° C., more preferably higher than 30° C.

In one preferred embodiment, the polymer composition has a volume resistivity of less than 10⁶ Ωcm, preferably less than 10⁴ Ωcm, more preferably less than 100 Ωcm.

In one preferred embodiment, the polymer composition further comprises at least one additive preferably selected from a light stabilizer, a heat stabilizer, a flame retardant, a plasticizer, a filler, a nanoparticle, an antistatic agent, a dye, a pigment, a mould-release agent, a flow assistant, or any mixture thereof.

In one preferred embodiment, graphene has a content of 4 wt. % to 50 wt. %, preferably 9 wt. % to 45 wt. %, more preferably 19 wt. to 40 wt. %, based on the total weight of the polymer composition.

In one preferred embodiment, graphene is in a form of granules, flakes, powders, films, sheets, nanoribbons, fibres, or a mixture thereof.

In one preferred embodiment, graphene has a bulk density within a range of 0.01 g/cm³ to 0.10 g/cm³, preferably 0.01 g/cm³ to 0.08 g/cm³, more preferably 0.01 g/cm³ to 0.05 g/cm³.

In one preferred embodiment, polyalkenamer has a degree of crystallinity of larger than 10%, preferably larger than 20%, more preferably larger than 25%.

The present disclosure further provides a moulded article produced from the polymer composition.

In one preferred embodiment, the moulded article is preferably a moulding, a film, a bristle, or a foam.

In one preferred embodiment, the moulded article is produced from a polymer matrix comprising at least one selected from polyethylene, polypropylene, polystyrene, natural rubbers, polybutadiene, styrene-butadiene rubber, acrylonitrile butadiene styrene, ethylene-propylene diene monomer rubber, polyvinyl chloride, polyvinylidene chloride, polytetrafluoroethylene, polyoxymethylene, polyketone, poly ether ketone, polyether ether ketone, polyethylene terephthalate, polyethylene naphthalate, polylactic acid, polycarbonate, ethylene vinyl acetate, poly(methyl methacrylate), polyamide, polyether block amide, polyimide, polyoxymethylene, polysulfone, polyether sulfone, polyphenylene sulfide, polyurethane, and polyurea.

In one preferred embodiment, the moulded article is produced by fused filament fabrication, stereolithography, binder jetting, material jetting, powder bed fusion, calendaring, compression-moulding, foaming, extrusion, coextrusion, blow moulding, 3D blow moulding, coextrusion blow moulding, co-extrusion 3D blow moulding, coextrusion suction blow moulding, or injection moulding.

In one preferred embodiment, the present disclosure further provides a use of the moulded article as a clothing element, sport element, sealing material, electrically conductive article, friction control element, transportation element, or structural element.

### BRIEF DESCRIPTION OF DRAWINGS

Throughout the specification, reference is made to the appended drawing, wherein:

FIG. 1 shows five thermal gravimetric curves for, respectively, from top to bottom, a composition having 44.87 wt. % of graphene; a composition having 29.31 wt. % of graphene; a composition having 19.53 wt. % of graphene; a composition having 9.90 wt. % of graphene; and a composition having 4.98 wt. % of graphene.

### DETAILED DESCRIPTION

The following description is used merely for illustration but is not to restrict the scope of the disclosure.

The term, “polymer” refers to, but is not limited to, oligomers, homopolymers, copolymers, terpolymers, and the like. The polymers may have various structures including, but not limited to, regular, irregular, alternating, periodic, random, block, graft, linear, branched, isotactic, syndiotactic, atactic, and the like.

The term, “graphene” refers to, single or few layers of graphite, be it pristine or chemically functionalized (e.g., graphene oxide, oxidized graphene), including, but not limited to, exfoliated graphite through mechanical, solvothermal, sonicated, or thermally reductive methods, monolayer or few-layer sp² carbon prepared by chemical vapor deposition or pyrolysis, or grew on a substrate.

[Graphene]

Graphene used herein is preferably selected from an exfoliated graphene, a thermally reduced graphene oxide, a functionalized graphene oxide, a mechanochemically prepared graphene, or a mixture thereof. More preferably, graphene is an exfoliated graphene, a thermally reduced graphene oxide, a functionalized graphene, or a mixture thereof. Among various functionalized graphene, graphene with halogen atoms or amino, amide, mercapto, carboxylic, carboxylic ester, carbonyl, epoxy, or hydroxy groups is preferably used in the polymer composition. These functionalities are preferably introduced into graphene by, for example, halogenation, oxidation, amino substitution, mercapto substitution, esterification, transesterification, reduction, hydrogenation, or combinations thereof.

Graphene used in the present disclosure has a carbon content of larger than 80 wt. %, preferably larger than 90 wt. %, still preferably larger than 95 wt. %.

Graphene according to the present disclosure is monolayered or few-layered. Among few-layered graphene, those with 2 to 10 layers of co-planar carbon-carbon network are preferably used. The graphene has a thickness of less than 10 nm, preferably less than 5 nm, more preferably less than 3 nm.

Graphene used herein has a bulk density within a range of preferably 0.01 g/cm³ to 0.10 g/cm³, more preferably 0.01 g/cm³ to 0.08 g/cm³, still more preferably 0.01 g/cm³ to 0.05 g/cm³.

Graphene is preferably in the form of granules, flakes, powders, films, sheets, nanoribbons, fibre, or a mixture thereof.

Graphene could be purchased commercially from various vendors under different trade names, for example, “graphene”, “graphene oxide”, “oxidized graphene”, “monolayer graphene film”, “graphene nanoplatelet”, etc.

[Polyalkenamer]

Polyalkenamer according to the present disclosure is prepared by ring opening polymerization of one or more cycloalkenes under catalysts. Preferably, the polyalkenamer comprises a trans-isomer content having trans- configuration of double bonds. The trans-isomer content is larger than 50 wt. %, preferably larger than 60 wt. %, more preferably larger than 70 wt. %, based on the weight of polyalkenamer.

Examples of polyalkenamers include polypentenamer, polyheptenamer, polynorbornene, polyoctenamer, polydecenamer, polydicyclopentadiene, and polydodecenamer. Those polyalkenamers are also commercially available in the brand names of, for example, Vestenamer® 6213 and Vestenamer® 8012 from Evonik Resource Efficiency GmbH, or Norsorex® from Astrotech Advanced Elastomerproducts GmbH. Preferred species is polyoctenamer under the brand name of Vestenamer® 8012, manufactured by Evonik Resource Efficiency GmbH.

Preferably, according to the present disclosure, the polyalkenamer has a melting point of higher than 5° C., preferably higher than 15° C., more preferably higher than 30° C.

The polyalkenamer has a degree of crystallinity of larger than 10%, preferably larger than 20%, more preferably larger than 25%.

Trans-isomer content herein refers to a weight percentage of trans-isomers within a total weight of polyalkenamer. In general, the trans-isomer content in the polyalkenamer influences the degree of crystallinity of the polyalkenamer. A greater crystallinity and consequently a higher melting temperature are obtained with increasing trans-isomer content.

Preferably, the polyalkenamer has a number-average molecular weight of larger than 100,000, more preferably larger than 120,000, still more preferably larger than 140,000. The number-average molecular weight could be measured using various methods, such as gel permeation chrometography.

[Polymer composition]

The polymer composition according to the present disclosure comprises, 1 wt. % to 60 wt. %, preferably 4 wt. % to 50 wt. %, more preferably 9 wt. % to 45 wt. %, still more preferably 19 wt. % to 40 wt. % of graphene, based on its total weight. Correspondingly, the polymer composition comprises, 40 wt. % to 99 wt. %, preferably 50 wt. % to 96 wt. %, more preferably 55 wt. % to 91 wt. %, still more preferably 60 wt. % to 81 wt. % of polyalkenamer, based on the total weight. The high concentration of graphene means that less space for storage will be required and the amount of polyalkenamer to be introduced will be reduced significantly when the graphene masterbatch is used to modify a target polymer.

Polymer composition according to the present disclosure could be realized in various ways. A two-roll mill, a kneader, or a twin-screw extruder may be used. However, other known techniques or processes for compounding polymers or rubbers will be contemplated by those skilled in the art.

In one specific embodiment, a two-roll mill was used for compounding graphene with polyalkenamer. The two-roll mill was preheated to a temperature range of 30° C. to 50° C. Then a pre-calculated amount of polyalkenamer in the form of pellets was added into the mill to be shaped to a sheet. Graphene powders were added into the mill in batch and the temperature was elevated to about 40° C. to 70° C. A black sheet was obtained and then it was fed into a pelletizer to produce graphene containing pellets.

According to the present disclosure, the polymer composition has a volume resistivity of less than 10⁶ Ωcm, preferably less than 10⁴ Ωcm, more preferably less than 100 Ωcm. The low resistivity promised a wide application in the field of conductive polymeric systems.

The polymer composition according to the disclosure may comprise as constituents, in addition to the components according to a) and b), further additives preferably selected from light stabilizers, heat stabilizers, flame retardants, plasticizers, fillers, nanoparticles, antistatic agents, dyes, pigments, mould-release agents or flow assistants, with an total amount not greater than 10 wt. %, preferably not greater than 5 wt. % based on the total weight of the polymer composition.

Preferably, the polymer composition according to the disclosure consists of the above specified constituents.

[Masterbatch]

The polymer composition according to the present disclosure may serve as a graphene masterbatch for introduction of graphene into a polymer matrix. A masterbatch is a concentrated mixture of additives or modifiers encapsulated during a heat process into a carrier resin which is then cooled and cut into a granular shape or pelletized. Masterbatch allows the processor to modify raw polymer economically during manufacturing process. As graphene usually takes forms of powders, flakes, platelets, nanoribbons, or other low-density forms, using a graphene masterbatch brings a lot of benefits, such as, reducing spaces needed for storing graphene, simplifying and expediting compounding process, and/or facilitating homogeneity of the final mixture.

In polymer compositions where a graphene presence is required, the masterbatch could be added into and compounded with the polymer matrix to achieve a homogeneous and convenient dispersion of graphene. The polymer matrix may be formed of one or more polymers such as polyethylene (PE), polypropylene (PP), polystyrene (PS), natural rubbers (NB), polybutadiene (butadiene rubber, BR), styrene-butadiene rubber (SBR), acrylonitrile butadiene styrene (ABS), ethylene-propylene diene monomer rubber (EPDM), polyvinyl chloride (PVC), polyvinylidene chloride (PVDC), polytetrafluoroethylene (PTFE), polyoxymethylene (POM), polyketone, poly ether ketone (PEK), polyether ether ketone (PEEK), polyethylene terephthalate (PET), polyethylene naphthalate (PEN), polylactic acid (PLA), polycarbonate (PC), ethylene vinyl acetate (EVA), poly(methyl methacrylate)

(PMMA), polyamide (PA), polyether block amide (PEBA), polyimide (PI), polyoxymethylene (POM), polysulfone, polyether sulfone (PES), polyphenylene sulfide (PPS), polyurethane (PU), polyurea, or the like. The graphene masterbatch can introduce superior performances in electrical conductivity, thermal conductivity and mechanical strengths into the polymer matrix. Benefiting from low melting point and high dispersity of polyalkenamer in numerous polymers, graphene can be dispersed evenly in the polymer mixture and aggregation could be controlled and reduced.

Besides the good dispersity of polyalkenamer in various polymers, the masterbatch may bring elasticity and resilience of polyalkenamer into the polymer matrix to which the masterbatch is added. In some case, polyalkenamer will reduce the negative impact of graphene to elongation, elasticity, resilience, or other mechanical properties of the polymer matrix. As polyalkenamer also serves a processing aid or plasticizer, addition of masterbatch may improve processability of the final composition.

Polymer composition of the present disclosure, specifically in the form of graphene masterbatch pellets, may be compounded with the above polymers in various ways, for example, dry blending, Banbury type mixing, co-rotating twin-screw extrusion, or any other suitable way. Devices such as mixer, extruder, or blender could be used during the compounding process. During the compounding, graphene masterbatch pellets may be added in batch or once. At last, a moulding composition containing graphene will be obtained.

The compounding may be realized through using a disperser for plastic or rubber processing, such as an internal mixer, a high-shearing mixer, a dynamic inline mixer, a homogenizer, an intensive inline mixer, a two-roll mixing mill, a homo-mixer, a ball mill, a bead mill, a high-pressure homogenizer, an ultrasonic homogenizer, a colloid mill, a mixing nozzle, or a melt blender.

After compounding, the moulding composition may be used to manufacture a moulded article, such as a board, a film, a bristle, a foam, or any other shape or form.

Preferably, the moulded article is produced from a polymer matrix comprising at least one selected from polyethylene (PE), polypropylene (PP), polystyrene (PS), natural rubbers (NB), polybutadiene (butadiene rubber, BR), styrene-butadiene rubber (SBR), acrylonitrile butadiene styrene (ABS), ethylene-propylene diene monomer rubber (EPDM), polyvinyl chloride (PVC), polyvinylidene chloride (PVDC), polytetrafluoroethylene (PTFE), polyoxymethylene (POM), polyketone, poly ether ketone (PEK), polyether ether ketone (PEEK), polyethylene terephthalate (PET), polyethylene naphthalate (PEN), polylactic acid (PLA), polycarbonate (PC), ethylene vinyl acetate (EVA), poly(methyl methacrylate) (PMMA), polyamide (PA), polyether block amide (PEBA), polyimide (PI), polyoxymethylene (POM), polysulfone, polyether sulfone (PES), polyphenylene sulfide (PPS), polyurethane (PU), polyurea. Graphene masterbatch may be added into the above-mentioned polymers as a modifier or an additive.

The manufacture may be realized through one or more methods including fused filament fabrication, stereolithography, binder jetting, material jetting, powder bed fusion, calendaring, compression-moulding, foaming, extrusion, coextrusion, blow moulding, 3D blow moulding, coextrusion blow moulding, coextrusion 3D blow moulding, coextrusion suction blow moulding, or injection moulding.

The moulded article may find its use as a clothing element (fabric, shoe sole, etc.), sport element (body protection, helmet, top sheet for skis or snowboards, inflated ball such as football or basketball, golf ball), sealing material (0-ring, support ring, lip seal, etc.), electrically conductive article (wire, conductive membrane, conductive plate, etc.), friction control element (glide ring, bushing, bearing, wearing component), transportation element (tire, belt, rope, gasket, ABS airbag, seat mattress), or structural element (frame, rod, block, foam, etc.).

The disclosure is illustrated by way of inventive example and comparative examples hereinbelow.

### EXAMPLES

Five samples with different concentrations of graphene in polyoctenamer were prepared from Vestenamer® 8012 and KNG®-G2 graphene. The five samples underwent volume resistivity test and thermal gravimetric analysis (TGA). The content of graphene for each sample is determined according to TGA by measuring the residual mass.

Vestenamer® 8012 available from Evonik Resource Efficiency GmbH is a semi-crystalline polyoctenamer having trans-isomer as the major composition and a high proportion of macrocycle polymers.

KNG®-G2 is a graphene product from Xiamen Knano Graphene Technology Corporation Limited, which consists of a majority of single-layer sheets and a minority of few-layer graphene having a high aspect ratio. The production process is based on exfoliation and involves no oxidation and reduction treatment, therefore the planar honeycomb structure in graphene is well preserved, giving a good electrical conductivity and stability. The bulk density is about 0.01-0.02 g/cm³. The average carbon content is about 98 wt. %.

Samples for graphene containing polyamide 12 composition and rubber composition were prepared along with their comparative samples. All the samples had their mechanical and electrical properties tested.

Vestamid® L1600 is a polyamide 12 with low viscosity from Evonik Resource Efficiency GmbH.

Buna® VSL 4526-2 is a solution styrene-butadiene rubber(S-SBR) for high performance tires from Arlanxeo Deutschland GmbH.

Taipol® BR 0150 is a 1,3-polybutadiene rubber, obtained with Ziegler cobalt type catalyst through solution polymerization from Taiwan Synthetic Rubber Corporation. It is 96% cis-configured and contains non-staining stabilizer.

Ultrasil® 7000 GR is a precipitated silica for use as a reinforcement filler in the rubber industry from Evonik Resource Efficiency GmbH.

Irganox® 1098 is a trade name for benzenepropanamide, N, N′-1,6-hexanediylbis[3,5-bis-4-hydroxy, manufactured by BASF SE and primarily used for stabilizing polymers, especially polyamides.

Making graphene-containing polyamide composite granules

1. Compounding graphene masterbatches with PA12:

Commercially available polyamide 12, 29.31 wt. % graphene masterbatch, and heat-stabilizer were dry blended and fed into the main port of a Coperion ZSK26mc co-rotating twin screw extruder and then mixed at 250° C. Polyamide composite granules were obtained after the mixture was sent to a pelletizer and pelletized.

2. Graphene powder with PA12:

As graphene powders were too fluffy to be fed directly into an extruder. First, 10 parts (based on weight) of graphene powder were dry blended with 90 parts of polyamide powder. Then the mixture was fed through a side feeder into the extruder. Other granules and heat stabilizer were dry blended and fed into the main port of extruder and melted at 250° C. Polyamide composite granules were obtained after the mixture was pelletized.

Making graphene-containing rubber composite granules

Process 1. Compounding graphene masterbatches and rubber:

Phase 1

Commercially available rubber BUNA® VSL 4526-2, Taipol® BR 0150, 19.53 wt. % graphene masterbatch, ULTRASIL® 7000 GR silica, antioxidants, and other auxiliaries were dry blended and fed into a W & P Model GK 1.5N Internal Rotor Mixer (Banbury style mixer) and then mixed at 150° C. to 160° C. The rotor speed was 80 rpm. Phase 1 lasted for 12 hours to 48 hours.

After phase 1 ended, a black rubber sheet was outputted by the mixer. The rubber sheet was then used during the second phase.

Phase 2

The rubber sheet made in Phase 1 and a vulcanization additive were mixed together in the same mixer as Phase 1. The rotation speed was elevated to 95 rpm while the temperature remained almost the same. Phase 2 lasted for 2 hours to 48 hours.

Phase 3

In this phase, sulphur and accelerators were added into the rubber sheet for vulcanization. The batch temperature was about 90° C. to 120° C. A final rubber sheet was outputted by the mixer.

The mixture was stored for 12 hours before vulcanization. Rubber composite samples were obtained by hot compressing the rubber sheet.

Process 2. Compounding graphene powders and rubber:

The process for preparing rubber composite samples from graphene powder and rubber was the same with Process 1, except the graphene masterbatch was substituted by graphene powders.

Process 3. Compounding graphene powder, polyoctenamer, and rubber:

The process for preparing rubber composite samples from graphene powder, polyoctenamer and rubber was the same with Process 1, except the graphene masterbatch was substituted by graphene powders and polyoctenamer.

[Test procedure]

Thermogravimetric analysis was conducted for each graphene masterbatch sample using a thermogravimetric tester. The samples were heated from room temperature to about 650° C. continuously in a speed of 10° C./min under nitrogen atmosphere, to determine thermal stability as well as weight percentage of graphene.

For all masterbatch samples, plates with 2mm thickness were prepared by hot compression. The plates were cut into 60mm*60mm*2mm (high resistivity) or 80mm*10mm*2mm (low resistivity), depends on the range into which the resistivity of the sample would fall.

The measurement standard for 60mm*60mm*2mm samples with high resistivity was IEC 62631-3-1 by ZC46A High Insulation Resistance Tester. The measurement standard for 80mm*10mm*2mm samples with low resistivity is ISO 3915 by Volume Resistivity Tester for Semi-Conductive Rubber and Plastic Materials.

For PA12 compositions, 60mm*60mm*2mm plates were prepared by injection molding, which were measured according to IEC 62631-3-1 standard using the same device with the graphene masterbatches. While for the rubber compositions, samples with 2mm thickness were prepared by hot compression and then cut into 60mm*60mm*2mm plates for test, whose volume resistivities were measured according to IEC 62631-3-1 standard using the same device with the graphene masterbatches.

Tensile modulus of elasticity, tensile stress at yield, tensile stress at break, and elongation at break were determined by Zwick Z020 materials testing system according to ISO 527, on ISO tensile specimens, type 1A, 170mm×10mm×4mm at a temperature (23±2) ° C., relative humidity (50±10) %. For notched impact strength, type of the failure as complete break was used, as described in

IS0179-1.

Mooney viscometer was used for measuring the Mooney viscosity of rubbers. The rubber compound, including the vulcanizing system, is shaped on the mill as 6-8 mm thick sheets. Round-shaped samples with 45 mm diameter are cut from the sheets. The samples are pierced in the middle in order to allow the rotor shaft to pass. Before the beginning of the measurement, the instrument is heated up to a desired temperature. After the sample is introduced, it takes a minute for the sample to reach the thermal equilibrium, and then the rotor is started.

The Mooney viscosity measurement ML(1+4) was conducted at 100° C. using a large rotor and was recorded as the torque when rotor had rotated for 4 minutes. The stocks were preheated at 100° C. for 1 minute before the rotor was started. The value generally indicates processing behavior of a rubber compound.

The scorch time MS t5 is the time required to increase 5 Mooney units during the Mooney scorch measurement at 130° C. It is used as an index to predict how fast the compound viscosity will rise during processes such as extrusion. It is believed that t5 value indicates the pre-vulcanization tendency of the compound.

[Results]

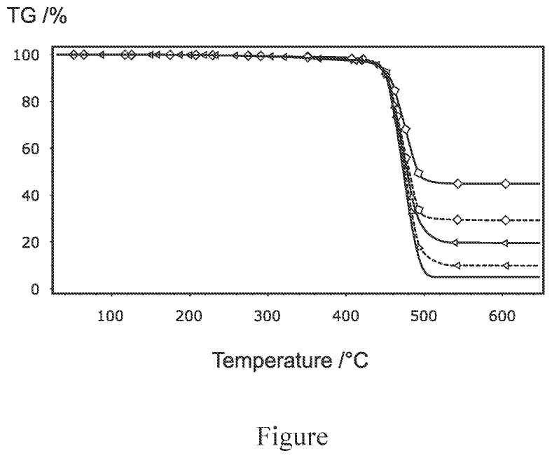

Thermal gravimetric analysis (TGA) was conducted for each sample to determine the weight loss under different temperatures. It was suggested in FIG. 1 that after being heated under 500° C., the polyoctenamer component will be either decomposed or vaporized, leaving only graphene in the solid phase. The analysis also confirmed the concentrations of graphene in the samples. The residual mass after the temperature reached above 600° C. was graphene, as it is neither volatile nor thermally instable. Also, the TGA curves shows an excellent thermal stability of the polymer composition of the present disclosure under 300° C.

The results for masterbatches are shown in Table 1.

TABLE 1
Graphene contents and volume resistivities
of examples 1-5 and comparative example

| Example | E1 | E2 | E3 | E4 | E5 | CE1 |
|---|---|---|---|---|---|---|
| Polyoctenamer content (%) | 55.13 | 70.69 | 80.47 | 90.10 | 95.02 | 100 |
| Graphene content (%) | 44.87 | 29.31 | 19.53 | 9.90 | 4.98 | 0 |
| Volume resistivity (Ω cm) | 2~3 | 10 | 1.5*10⁵ | 3.0*10⁷ | 1.1*10¹⁶ | 1.1*10¹⁶ |

From the above table, it is clear that under low concentration of graphene, the volume resistivity of masterbatch will not deviate from that of polyoctenamer, comparing inventive example E5 and comparative example CE1. With the increasing concentration of graphene, the volume resistivity of polymer composition decreases significantly. After the graphene content reaches about 30 wt. %, the volume resistivity is comparable to that of semiconductor or sea water. Given that the dispersiveness of graphene in polyoctenamer might be uneven, especially under a concentration as high as 30 wt. %, the huge change with respect to electrical conductivity is prominent and may give rise to new applications, especially in electrical industries.

To test compatibility with other polymers, graphene masterbatches were added into two different polymers, polyamide and polybutadiene. Mechanical tests were conducted to analyse effects brought by graphene masterbatch to the polymer matrices. Specifically, the 29.31 wt. % graphene masterbatch was added into polyamide Vestamid® L1600 to prepare two polyamide compositions with about 1 wt. % and 2 wt. % of graphene, respectively. The 19.53 wt. % graphene masterbatch was added into polybutadiene to prepare one rubber composition with about 1 wt. % of graphene.

Polyamide moulding compositions containing graphene

Table 2 shows formulations and properties of polyamide moulding compositions.

TABLE 2
Compositions and properties of examples 6, 7 and comparative examples 2-5

| | | | | | | |
|---|---|---|---|---|---|---|
| Example | E6 | E7 | CE2 | CE3 | CE4 | CE5 |

Recipe - PA12

| | | | | | | |
|---|---|---|---|---|---|---|
| Vestamid ® L1600 (%) | 96.05 | 92.55 | 98.55 | 97.55 | 96.05 | 92.55 |
| Vestenamer ® 8012 (%) | — | — | — | — | 2.5 | 5 |
| KNG-G2 ® graphene (%) | — | — | 1 | 2 | 1 | 2 |
| 29.31 wt. % masterbatch (%) | 3.5 | 7 | — | — | — | — |
| Irganox ® 1098 (%) | 0.45 | 0.45 | 0.45 | 0.45 | 0.45 | 0.45 |

Test Results Comparison

| | | | | | | |
|---|---|---|---|---|---|---|
| E-modulus (MPa) | 1750 | 1750 | 1870 | 1930 | 1780 | 1780 |
| Stress at yield (MPa) | 45.6 | 42.2 | 48.8 | 48.3 | 45.8 | 43.0 |
| Stress at break (MPa) | 33.4 | 33.6 | 37.1 | 46.1 | 33.3 | 38.1 |
| Elongation at break (%) | 32.9 | 20.0 | 17.4 | 14.8 | 19.9 | 18.4 |
| Notched impact strength (kJ/m²) | 3.4 C | 3.7 C | 2.4 C | 2.4 C | 3.2 C | 2.8 C |

Examples E6 and CE4 all have approximately the same chemical composition despite that example E6 was prepared by mixing premixed graphene-polyoctenamer masterbatch with polyamide, while example CE4 was prepared by mixing the same amounts of graphene, polyoctenamer, and polyamide in the same time. The same applies for examples E7 and CES.

After the introduction of graphene, either in the form of standalone graphene, or graphene masterbatch, elongation at break of polymer composition decrease significantly (the data for unmodified polyamide Vestamid® L1600 is not shown here). Nevertheless, elongation at break of example E6 or E7 was higher than example CE4 or CE5, indicating a better resilience.

Notched impact strength increases as the content of graphene in the polymer composition increases. Furthermore, notched impact strength of example E6 or E7 was higher than example CE4 or CE5, indicating a higher impact resistance.

Without wishing to be bound by theory, it is believed that the higher resilience and impact resistance were resulted from a high dispersity of graphene within polyamide matrix due to premix of polyoctenamer and graphene.

Rubber moulding compositions containing graphene

Table 3 shows formulations and properties of rubber moulding compositions.

TABLE 3
Compositions and properties of example
8 and comparative examples 6-8

| | | | | |
|---|---|---|---|---|
| Example | E8 | CE6 | CE7 | CE8 |

Recipe - Rubber

| | | | | |
|---|---|---|---|---|
| BUNA ® VSL 4526-2 (parts) | 96.25 | 96.25 | 96.25 | 96.25 |
| Taipol ® BR 0150 (parts) | 30 | 30 | 30 | 30 |
| ULTRASIL ® 7000 GR (parts) | 80 | 80 | 80 | 80 |
| Vestenamer ® 8012 (parts) | — | — | — | 4 |
| KNG-G2 ® graphene (parts) | — | — | 1 | 1 |
| 19.53 wt. % masterbatch (parts) | 5 | — | — | — |
| Other additives (parts) | 34.85 | 34.85 | 34.85 | 34.85 |

Test Results Comparison

| | | | | |
|---|---|---|---|---|
| Mooney ML 1 + 4 (100° C.) | 52 | 53 | 54 | 52 |
| (MU) | | | | |
| Mooney MS t5 (130° C.) (min) | 40 | 38 | 38 | 39 |
| 100% modules (MPa) | 2.3 | 2.1 | 2.3 | 2.2 |
| Tensile strength (MPa) | 17.6 | 16.0 | 17.5 | 17.1 |
| Elongation at break (%) | 409 | 384 | 396 | 407 |
| DIE C Tear (N/mm) | 41 | 40 | 37 | 40 |

Examples E8 and CE8 all have approximately the same chemical composition despite that example E8 was prepared by mixing premixed graphene-polyoctenamer masterbatch with rubber and other additives, while example CE8 was prepared by mixing the same amounts of graphene, polyoctenamer, rubber, and other additives in the same time.

After the introduction of graphene, either in the form of standalone graphene, or graphene masterbatch, tensile strength of polymer composition increases significantly compared with example CE6. Nevertheless, tensile strength of example E8 was slightly higher than example CE8. Viscosity data confirmed that addition of graphene masterbatch would not bring negative impact on viscosity or dynamic properties.

Without wishing to be bound by theory, it is believed that the higher tensile strength was resulted from a high dispersity of graphene within rubber matrix due to premix of polyoctenamer and graphene.

Having described the present disclosure in detail, various modifications and alterations of the embodiments will be apparent to those skilled in the art without departing from the spirit and scope of the disclosure. It should be understood that the disclosure is not limited to illustrative embodiments set forth herein.

1. A polymer composition,. comprising:
based on a total weight of the polymer composition,
a) 40 wt. % to 99 wt. % of a polyalkenamer derived from at least one cycloalkene having 5 to 12 carbon atoms, wherein the polyalkenamer has a trans-isomer content larger than 50 wt. %, based on a weight of the polyalkenamer, and
b) 1 wt. % to 60 wt. % of graphene.

2. The polymer composition according to claim 1, wherein the graphene is selected from the group consisting of an exfoliated graphene, a thermally reduced graphene oxide, a fwictionalized graphene oxide, a tnechanochemically prepared graphene, and a mixture thereof.

3. The polymer composition according to claim 1, wherein the polyalkenamer comprises a polyoctenatner.

4. The polymer composition according to claim 1, wherein the polyalkenarner has a melting point of higher than 5° C.

5. The polymer composition according to claim 1, wherein the polymer composition has a volume resistivity of less than 10⁶ Ωcm.

6. The polymer composition according to claim 1, wherein the polymer composition further comprises at least one additive.

7. The polymer composition according to claim 1, wherein the polymer composition comprises the graphene in a content of 4 wt. % to 50 wt. %, based on the total weight of the polymer composition.

8. The polymer composition according to claim 1, wherein the graphene is in a form of granules, flakes, powders, films, sheets, nanoribbons, fibres, or a mixture thereof

9. The polymer composition according to claim 1, wherein the graphene has a bulk density within a range of 0.01 g/cm³ to 0.10 g/cm³.

10. The polymer composition according to claim 1, wherein the polyalkenamer has a degree of crystallinity of larger than 10%.

11. A moulded article produced from the polymer composition according to claim 1.

12. The moulded article according to claim 11, wherein said moulded article is a board, a film, a bristle, or a foam.

13. The moulded article according to claims 11, wherein said moulded article is produced from a polymer matrix comprising at least one selected from the grow consisting of polyethylene, polypropylene, polystyrene, a natural ruhher[[s]], polybutadiene, styrene-butadiene rubber, acrylonitrile butadiene styrene, ethylene-propylene diene monomer rubber, polyvinyl chloride, polyvinylidene chloride, polytetrafluoroethylene, polyoxymethylene, polyketone, poly ether ketone, polyether ether ketone, polyethylene terephthalate, polyethylene naphthalate, polylactic acid, polycarbonate, ethylene vinyl acetate, poly(methyl methacrylate), polyamide, polyether block amide, polyimide, polyoxymethylene, polysulfone, polyether sulfone, polyphenylene sulfide, polyurethane, and polyurea.

14. The moulded article according to claim 11, produced by fused filament fabrication, stereolithography, binder jetting, material jetting, powder bed fusion, calendaring, compression-moulding, foaming, extrusion, coextrusion, blow moulding, 3D blow moulding, coextrusion blow moulding, coextrusion 3D blow moulding, coextrusion suction blow moulding, or injection moulding.

15. The moulded article according to claim 11, wherein the moulded article is a clothing element, sport element, sealing material, electrically conductive article, friction control element, transportation element, or structural element.)

16. The polymer composition according to claim 4, wherein the polyalkenamer has a melting point of higher than 30° C.)

17. The polymer composition according to claim 5, wherein the polymer composition has a volume resistivity of less than 100 Ωcm.

18. The polymer composition according to claim 6, wherein the at least one additive is selected from the group consisting of a light stabilizer, a heat stabilizer, a flame retardant, a plasticizer, a filler, a nanoparticle, an antistatic agent, a dye, a pigment, a mould-release agent, a flow assistant, and a mixture thereof.

19. The polymer composition according to claim 7, wherein the polymer composition comprises the graphene in a content of 19 wt. % to 40 wt. %, based on the total weight of the polymer composition.

20. The polymer composition according to claim 10, wherein the polyalkenamer has a degree of crystallinity of larger than 25%.
